(19) United States
(12) Patent Application Publication
(10) Pub. No.: US 2018/0336534 A1
(43) Pub. Date: Nov. 22, 2018

(54) SYSTEM AND METHOD FOR PREDICTIVE MAINTENANCE OF FACILITY

(71) Applicant: BEGAS CO., LTD., Seoul (KR)

(72) Inventor: Do-Hyun KIM, Seoul (KR)

(21) Appl. No.: 15/531,578

(22) PCT Filed: Nov. 13, 2015
(86) PCT No.: PCT/KR2015/012224

§ 371 Date: May 30, 2017

(30) Foreign Application Priority Data
Nov. 27, 2014 (KR) 10-2014-0167244

(51) Int. Cl. G06Q 10/00; G06N 7/00

(52) U.S. Cl. CPC G06Q 10/20; G06N 7/005

(57) ABSTRACT

A system for the predictive maintenance of a facility includes a health indicator generator for generating a health indicator for determining the normal state or defect state of a facility, a defect facility determiner for determining, through the health indicator, whether a facility is a defect facility and the defect type of the facility, a defect facility predictor for predicting the remaining lifespan or defect probability of the facility; and a first alarmer for generating a first alarm if the predicted remaining lifespan becomes equivalent to or below a pre-set value, or if the predicted defect probability becomes equivalent to or above a pre-set value.

### TECHNICAL FIELD

The present invention relates to a system and a method for predictive maintenance of a facility, and more particularly, to a system and a method for predictive maintenance of a facility which are intended to prevent a defect from occurring in a facility.

### BACKGROUND ART

In general, a facility (or equipment) used to produce a product deteriorates over time, and performance thereof is degraded. Accordingly, a defect occurs in the facility and leads to production of defective manufactures or a halt in production of manufactures. Conventional facility maintenance methods include reactive maintenance (RM), preventive maintenance (PM), condition-based maintenance (CBM), etc., but they have limitations as fundamental solutions for preventing a defect from occurring in a facility.

Specifically, RM denotes repairing a facility after a defect occurs in the facility as a posterior countermeasure but leads to an unexpected down time and a loss caused by a trouble in production. Also, PM is a method of periodically maintaining a facility but has a problem in that too much manpower is put into a healthy facility and leads to missing of an opportunity if a defect occurs before maintenance of a facility and to loss caused by the defect. Further, CBM is an experience-based monitoring method centered on a single variate for maintaining a facility according to a state of a particular variable but has a problem in that many false alarms are generated because a simple experiential management standard is used.

### PRIOR ART LITERATURE

### Patent Literature

(Patent Literature 1) Korean Unexamined Patent Publication No. 10-2014-0038265 (Mar. 28, 2014).

### DISCLOSURE

### Technical Problem

The present invention is directed to providing a system and a method for predictive maintenance of a facility which can maximize sales figures and profit margins by predicting a time point at which a defect occurs in a facility using a multivariate analysis technique, efficiently identifying a defect factor which is not conventionally identified, and calculating an optimal maintenance time point.

### Technical Solution

One aspect of the present invention provides a system for predictive maintenance of a facility, the system including: a health indicator generator configured to generate health indicators for determining a normal state or a defect state of a facility; a defect facility determiner configured to determine whether the facility is a defective facility and a defect type of the facility through the health indicators; a defect facility predictor configured to predict a remaining lifespan or a defect probability of the facility; and a first alarmer configured to generate a first alarm when the predicted remaining lifespan becomes a pre-set value or less or the predicted defect probability becomes a pre-set value or more.

The health indicators may include a univariate indicator composed of one variable for determining the normal state or the defect state of a facility and a multivariate indicator composed of a combination of a plurality of variables.

The health indicator generator may select a variable, which is changed by a pre-set value or more before a defect of the facility and is changed by a pre-set value or more before and after the defect of the facility, as the univariate indicator from among the plurality of variables.

The health indicator generator may select a combination, which is changed by a pre-set value or more before a defect of the facility and is changed by a pre-set value or more before and after the defect of the facility, as the multivariate indicator from among a plurality of combinations of the variables.

The variable may be any one of temperature, pressure, voltage, current, speed, and tension indicating a state or a processing condition of a particular facility.

Each of the health indicators may be previously matched to one or more facilities.

When the health indicators deviate from a pre-set management line, the defect facility determiner may determine the facility as a defective facility and determine the defect type of the facility by checking kinds of the univariate indicator and the multivariate indicator included in the health indicators.

The defect facility predictor may draw a model, which uses at least one of multiple linear regression (MLR), partial least squares (PLS), ridge, least absolute shrinkage and selection operator (LASSO), smoothly clipped absolute deviation (SCAD), minimax concave penalty (MCP), support vector machine (SVM), bagging, boosting, and random forest and uses the remaining lifespan of the facility and one or more of the plurality of health indicators respectively as a dependent variable and independent variables, and predict the remaining lifespan of the facility.

The defect probability predictor may draw a model, which uses at least one of a generalized linear model (GLM), linear discriminant analysis (LDA), quadratic discriminant analysis (QDA), SVM, bagging, boosting, and random forest, support vector machine (SVM), bagging, boosting, and random forest and has whether there is a defect in the facility and one or more of the plurality of health indicators respectively as a dependent variable and independent variables, and predict the defect probability of the facility.

The system may further include a second alarmer configured to generate a second alarm based on a defect occurrence ratio of the facility corresponding to a pre-set time.

The second alarmer may generate one or more criteria in consideration of a ratio of cases in which the second alarm has been generated but no defect actually occurs (referred to as “false alarm ratio”) and a ratio of cases in which the second alarm has not been generated but a defect actually occurs (referred to as “leakage ratio”), generate an alarm rule that optimizes the criteria, and generate the second alarm when the alarm rule is satisfied.

w₁*False alarm ratio+w₂*Leakage ratio [Expression 1]

(where w₁ is a weight coefficient for importance of a false alarm ratio, and w₂ is a weight coefficient for importance of a leakage ratio)

Leakage ratio s.t. False alarm ratio≤α [Expression 2]

(a leakage ratio under a condition that a false alarm ratio is a pre-set level α or less)

False alarm ratio s.t. Leakage ratio≤β [Expression 3]

(a false alarm ratio under a condition that a leakage ratio is a pre-set level β or less).

The alarm rule may indicate that k or more of K health indicators deviate from a pre-set management line during the pre-set time, and the second alarmer may calculate values of K and k minimizing values of the criteria.

The system may further include a time-of-maintenance calculator configured to calculate an optimal maintenance time point in consideration of a repair cost of the defective facility and an opportunity cost for replacing the defective facility.

The time-of-maintenance calculator may calculate the repair cost according to Expression 4 or 5 and calculate the opportunity cost according to Expression 6:

Repair cost=(ET+TI*t)*M*B [Expression 4]

(where ET is an estimated repair time of a particular facility, TI is a repair time increment per unit time, M is a number of manufactures produced per unit time, B is a profit per product, t=0, . . . , and T, and T is a remaining lifespan when the first alarm is generated);

Repair cost=(EC+CI*t) [Expression 5]

(where EC is an estimated repair cost of a particular facility, CI is a repair cost increment per unit time, t=0, . . . , and T, and T is a remaining lifespan when the first alarm is generated); and

Opportunity cost=(T−t)*V/L [Expression 6]

(where V is a price of a particular facility, L is an average lifespan, t=0, . . . , and T, and T is a remaining lifespan when the first alarm is generated).

The time-of-maintenance calculator may determine a time point at which a sum of the repair cost and the opportunity cost is minimized as the optimal maintenance time point.

Another aspect of the present invention provides a method for predictive maintenance of a facility, the method including: generating health indicators for determining a normal state or a defect state of a facility; determining whether the facility is a defective facility and a defect type of the facility through the health indicators; predicting a remaining lifespan or a defect probability of the facility; and generating a first alarm when the predicted remaining lifespan becomes a pre-set value or less or the predicted defect probability becomes a pre-set value or more.

The health indicators may include a univariate indicator composed of one variable for determining the normal state or the defect state of a facility and a multivariate indicator composed of a combination of a plurality of variables.

The generating of the health indicators may include selecting a variable, which is changed by a pre-set value or more before a defect of the facility and is changed by a pre-set value or more before and after the defect of the facility, as the univariate indicator from among a plurality of the variables.

The generating of the health indicators may include selecting a combination, which is changed by a pre-set value or more before a defect of the facility and is changed by a pre-set value or more before and after the defect of the facility, as the multivariate indicator from among a plurality of combinations of the variables.

The variable may be any one of temperature, pressure, voltage, current, speed, and tension indicating a state or a processing condition of a particular facility.

Each of the health indicators may be previously matched to one or more facilities.

The determining of whether the facility is a defective facility and the defect type of the facility may include, when the health indicators deviate from a pre-set management line, determining the facility as a defective facility and determining the defect type of the facility by checking kinds of the univariate indicator and the multivariate indicator included in the health indicators.

The predicting of the remaining lifespan or the defect probability of the facility may include drawing a model, which uses at least one of MLR, PLS, ridge, LASSO, SCAD, MCP, SVM, bagging, boosting, and random forest and has the remaining lifespan of the facility and one or more of the plurality of health indicators respectively as a dependent variable and independent variables, and predicting the remaining lifespan of the facility.

The predicting of the remaining lifespan or the defect probability of the facility may include drawing a model, which uses at least one of a GLM, LDA, QDA, SVM, bagging, boosting, and random forest and has whether there is a defect in the facility and one or more of the plurality of health indicators respectively as a dependent variable and independent variables, and predicting the defect probability of the facility.

The method may further include generating a second alarm based on a defect occurrence ratio of the facility corresponding to a pre-set time.

The generating of the second alarm may include generating one or more criteria in consideration of a ratio of cases in which the second alarm has been generated but no defect actually occurs (referred to as “false alarm ratio” below) and a ratio of cases in which the second alarm has not been generated but a defect actually occurs (referred to as “leakage ratio” below), generating an alarm rule that optimizes the criteria, and generating the second alarm when the alarm rule is satisfied.

The criteria may satisfy any one of Expressions 1 to 3:

w₁*False alarm ratio+w₂*Leakage ratio [Expression 1]

(where w₁ is a weight coefficient for importance of a false alarm ratio, and w₂ is a weight coefficient for importance of a leakage ratio)

Leakage ratio s.t. False alarm ratio≤α [Expression 2]

(a leakage ratio under a condition that a false alarm ratio is a pre-set level α or less)

False alarm ratio s.t. Leakage ratio≤β [Expression 3]

(a false alarm ratio under a condition that a leakage ratio is a pre-set level β or less).

The alarm rule may indicate that k or more of K health indicators deviate from a pre-set management line during the pre-set time, and values of K and k may minimize values of the criteria.

The method may further include calculating an optimal maintenance time point in consideration of a repair cost of the defective facility and an opportunity cost for replacing the defective facility.

The calculating of the optimal maintenance time point may include calculating the repair cost according to Expression 4 or 5 and calculating the opportunity cost according to Expression 6:

Repair cost=(ET+TI*t)*M*B [Expression 4]

(where ET is an estimated repair time of a particular facility, TI is a repair time increment per unit time, M is a number of manufactures produced per unit time, B is a profit per product, t=0, . . . , and T, and T is a remaining lifespan when the first alarm is generated);

Repair cost=(EC+CI*t) [Expression 5]

(where EC is an estimated repair cost of a particular facility, CI is a repair cost increment per unit time, t=0, . . . , and T, and T is a remaining lifespan when the first alarm is generated); and

Opportunity cost=(T−t)*V/L [Expression 6]

(where V is a price of a particular facility, L is an average lifespan, t=0, . . . , and T, and T is a remaining lifespan when the first alarm is generated).

The calculating of the optimal maintenance time point may include determining a time point at which a sum of the repair cost and the opportunity cost is minimized as the optimal maintenance time point.

### Advantageous Effects

According to exemplary embodiments of the present invention, it is possible to predict a defect in a facility by establishing a prediction model on the basis of a past defect pattern of the facility and monitoring the facility in real time using the established model. Further, it is possible to efficiently identify a defect factor, which is not conventionally identified, using a multivariate analysis technique.

Also, according to exemplary embodiments of the present invention, an alarm is generated to a user in an objective and statistical way before a defect of a facility occurs, so that the user can make a maintenance plan and also an accident can be prevented.

### DESCRIPTION OF DRAWINGS

FIG. 1 is a block diagram illustrating a system for predictive maintenance of a facility according to an exemplary embodiment of the present invention.

FIG. 2 is a graph showing a remaining lifespan of a facility predicted by a remaining lifespan predictor according to an exemplary embodiment of the present invention.

FIG. 3 is a graph showing a defect probability of a facility predicted by a defect probability predictor according to an exemplary embodiment of the present invention.

FIGS. 4A and 4B are example diagrams of a case in which a second alarm is generated by a second alarmer.

FIG. 5 is a diagram illustrating a process in which a time-of-maintenance calculator calculates an optimal maintenance time point according to an exemplary embodiment of the present invention.

FIG. 6 is a flowchart illustrating a method for predictive maintenance of a facility according to an exemplary embodiment of the present invention.

FIG. 7 is a flowchart illustrating a method of selecting a univariate indicator according to an exemplary embodiment of the present invention in step S602 of FIG. 6.

FIG. 8 is a flowchart illustrating a method of selecting a multivariate indicator according to an exemplary embodiment of the present invention in step S602 of FIG. 6.

FIG. 9 is a flowchart illustrating a method in which a second alarmer generates a second alarm according to an exemplary embodiment of the present invention in step S608 of FIG. 6.

FIG. 10 is a flowchart illustrating step S910 of FIG. 9.

### MODES OF THE INVENTION

The present invention allows various modifications and several embodiments, and particular embodiments thereof will be exemplified with reference to drawings and described in detail. However, this is not intended to limit the present invention to particular modes of practice, and it is to be appreciated that all modifications, equivalents, and substitutes which do not depart from the spirit and technical scope of the present invention are encompassed in the present invention.

In description of the present invention, when it is determined that detailed description of the known art related to the present invention may obscure the gist of the present invention, the detailed description will be omitted. Terms which will be described below are defined in consideration of functionality in the present invention, which may vary according to an intention of a user or an operator or usual practice. Therefore, the definition should be made on the basis of the overall content of the specification.

The spirit of the present invention is determined by the claims, and the following exemplary embodiments are just provided to efficiently describe the advanced spirit of the present invention to those of ordinary skill in the art.

Hereinafter, detailed embodiments of the present invention will be described with reference to drawings. However, these are only exemplary embodiments, and the present invention is not limited thereto.

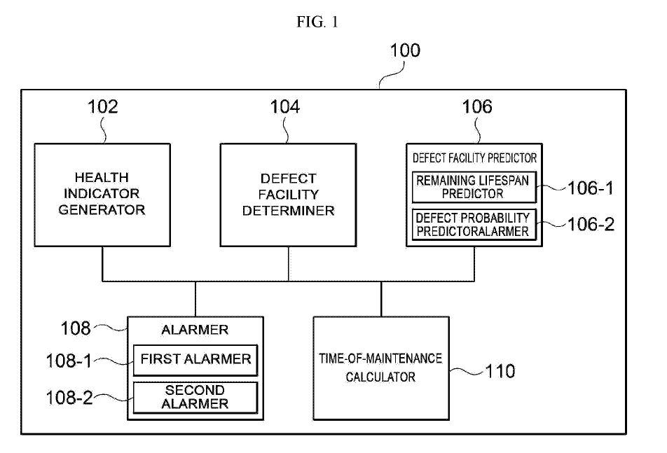

FIG. 1 is a block diagram illustrating a system 100 for predictive maintenance of a facility according to an exemplary embodiment of the present invention. As shown in FIG. 1, the system 100 for predictive maintenance of a facility according to an exemplary embodiment of the present invention includes a health indicator generator 102, a defect facility determiner 104, a defect facility predictor 106, an alarmer 108, and a time-of-maintenance calculator 110. In an exemplary embodiment of the present invention, a facility is used as a broad meaning including an installation, equipment, an apparatus, etc. used to manufacture a particular product (e.g., a home appliance, a mobile device, a laptop computer, a personal computer (PC), etc.) and may be, for example, chemical vapor deposition (CVD) equipment, a motor, and the like.

The health indicator generator 102 generates a health indicator. A health indicator indicates health status of each facility and is used to determine a normal state or a defect state of each facility. A health indicator may include a univariate indicator composed of one variable for determining the normal state or the defect state of a facility and a multivariate indicator composed of a combination (e.g., a linear combination) of a plurality of variables. Here, a variable constituting a univariate indicator and a multivariate indicator may be any one of temperature, pressure, voltage, current, speed, and tension indicating a state or a processing condition of a particular facility. A univariate indicator may be, for example, a temperature of a first facility (not shown), a pressure of the first facility, a voltage input to a second facility (not shown), etc., and a multivariate indicator may be a linear combination of the variables, for example, a*temperature+b*pressure+c*voltage (where a, b, and c are constants). Meanwhile, the aforementioned variables are just exemplary embodiments, and the kind of a variable constituting a univariate indicator and a multivariate indicator is not limited thereto.

Referring to a process in which the health indicator generator 102 generates a health indicator, the health indicator generator 102 may select a variable which is changed by a pre-set value or more before a defect of a facility and is changed by a pre-set value or more before and after the defect of the facility as a univariate indicator from among a plurality of variables. As an example, when the temperature of the first facility is changed by the pre-set value, e.g., 1 degree, or more before a defect of the facility and is changed by the pre-set value, e.g., 3 degrees, or more before and after the defect of the facility, the health indicator generator 102 may select the temperature of the first facility as a univariate indicator of the first facility. In other words, the temperature of the first facility may be a health indicator which is used to determine the normal state or the defect state of the first facility. Also, when the number of vibrations of the first facility is changed by a pre-set value or more before a defect of the first facility and is changed by a pre-set value before and after the defect of the first facility, the health indicator generator 102 may select the number of vibrations of the first facility also as a univariate indicator of the first facility. A variable constituting a univariate indicator may be determined with reference to a simulation, a history of the corresponding facility, or the like. Also, the health indicator generator 102 may generate one or more univariate indicators for one facility and then match the facility and the univariate indicators to each other.

Next, the health indicator generator 102 may select a combination of a plurality of variables which is changed by a pre-set value or more before a defect of a facility and is changed by a pre-set value or more before and after the defect of the facility as a multivariate indicator from among combinations of a plurality of variables. As an example, when a combination of a plurality of variables of the second facility, for example, a*temperature+b*pressure+c*voltage (where a, b, and c are constants), is changed by the pre-set value, e.g., 3, or more before a defect of the second facility and is changed by the pre-set value, e.g., 5, or more before and after the defect of the second facility, the health indicator generator 102 may select the combination as a multivariate indicator of the second facility. The kinds of variables and constants constituting a multivariate indicator may be determined with reference to a simulation, a history of the corresponding facility, or the like. In particular, when there is defect information of a facility, the health indicator generator 102 may generate a multivariate indicator using a multivariate generation method (e.g., partial least analysis, etc.) in which a variable of facility status and the defect information are used. When there is no defect information of a facility, the health indicator generator 102 may generate a multivariate indicator using a multivariate generation method (principal component analysis (PCA), etc.) in which only a variable of facility status is used. Also, the health indicator generator 102 may generate one or more multivariate indicators for one facility and then match the facility and the multivariate indicators to each other.

Meanwhile, the “pre-set values” which are used to determine a univariate indicator and a multivariate indicator may be determined using an experiential distribution, a variable which is known to best reflect a defect of the corresponding facility or a distribution of the variable, or bootstrap sampling. Also, whether a change of a pre-set value or more is made before a defect may be determined using, for example, a tree classification algorithm, a cumulative sum (CUSUM) algorithm, etc., and whether a change of a pre-set value or more is made before and after the defect may be determined using, for example, a T-test, an F-test, a Wilcox test, or the like.

The defect facility determiner 104 determines a facility in which a defect has occurred and a defect type of the facility through health indicators generated by the health indicator generator 102. As described above, the health indicators include one or more univariate indicators and multivariate indicators, and each health indicator is previously matched to one or more facilities. For example, the first facility may be previously matched to first to third univariate indicators and first to fourth multivariate indicators. Accordingly, the defect facility determiner 104 may monitor health indicators and determine a facility whose particular health indicator (or a univariate indicator and a multivariate indicator included in the health indicator) deviates from a pre-set management line as a defective facility. Here, the management line is a reference value used to determine whether a facility is a defective facility, and for example, may differ by a pre-set value (e.g., 3σ, 6σ, or the like) from an average of a health indicator obtained while the facility is normal. As an example, when a health indicator differs by 3σ(where σ is a standard deviation) or more from an average of the health indicator obtained while the facility is normal, the defect facility determiner 104 may determine the facility as a defective facility. In this case, the defect facility determiner 104 may determine a defect type of the facility by checking the kinds of a univariate indicator and a multivariate indicator included in the health indicator. When a univariate indicator of temperature is included in the health indicator, the defect facility determiner 104 may determine that temperature included in the health indicator is one of defect factors of the facility. Meanwhile, the defect facility determiner 104 may determine presence or absence of a defect of a facility and a defect type of the facility by considering both a univariate indicator and a multivariate indicator. Since each health indicator includes one or more univariate indicators and multivariate indicators as described above, the defect facility determiner 104 may more efficiently determine presence or absence of a defect of a facility and a defect type of the facility while simultaneously monitoring the univariate indicators and the multivariate indicators.

The defect facility predictor 106 predicts a remaining lifespan or a defect probability of a facility. The defect facility predictor 106 may include a remaining lifespan predictor 106-1 and a defect probability predictor 106-2. The remaining lifespan predictor 106-1 may predict a remaining lifespan of a facility, and the defect probability predictor 106-2 may predict a defect probability of a facility.

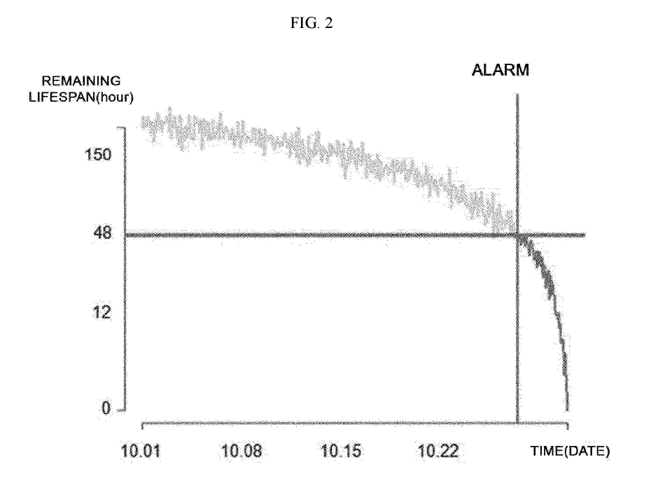

FIG. 2 is a graph showing a remaining lifespan of a facility predicted by the remaining lifespan predictor 106-1 according to an exemplary embodiment of the present invention. Here, the horizontal axis denotes time, and the vertical axis denotes a remaining lifespan.

The remaining lifespan predictor 106-1 may draw models, which use at least one of multiple linear regression (MLR), partial least squares (PLS), ridge, least absolute shrinkage and selection operator (LASSO), smoothly clipped absolute deviation (SCAD), minimax concave penalty (MCP), support vector machine (SVM), bagging, boosting, and random forest and have a remaining lifespan of a facility and one or more of a plurality of health indicators respectively as a dependent variable and independent variables, and predict a remaining lifespan of a facility. The remaining lifespan predictor 106-1 may select a model having the least prediction error from among these models and predict a remaining lifespan of a facility using the selected model.

In particular, since the dependent variable is continuous, the remaining lifespan predictor 106-1 may predict a remaining lifespan of a facility using a regression analysis method, such as MLR, PLS, ridge, LASSO, SCAD, bagging, boosting, random forest, or the like. Also, the remaining lifespan predictor 106-1 may predict a remaining lifespan of a facility using a time-series analysis method, such as autoregressive integrated moving average (ARIMA), etc., when an independent variable is time, and may predict a remaining lifespan of a facility using a survival analysis method, such as exponential distribution, Weibull distribution, log-logistic distribution, gamma distribution, exponential-logarithmic distribution, the Kaplan-Meier method, the Cox proportional hazard model, etc., when the dependent variable is a time-to-event. The remaining lifespan predictor 106-1 using such a variety of methods may draw a model, which has a remaining lifespan of a facility and one or more of a plurality of health indicators respectively as a dependent variable and independent variables, and predict a remaining lifespan of a facility more efficiently and accurately. As described below, when the remaining lifespan predicted by the remaining lifespan predictor 106-1 is equal to or less than a pre-set value, the alarmer 108 generates an alarm so that a user can prepare for maintenance of the facility in advance.

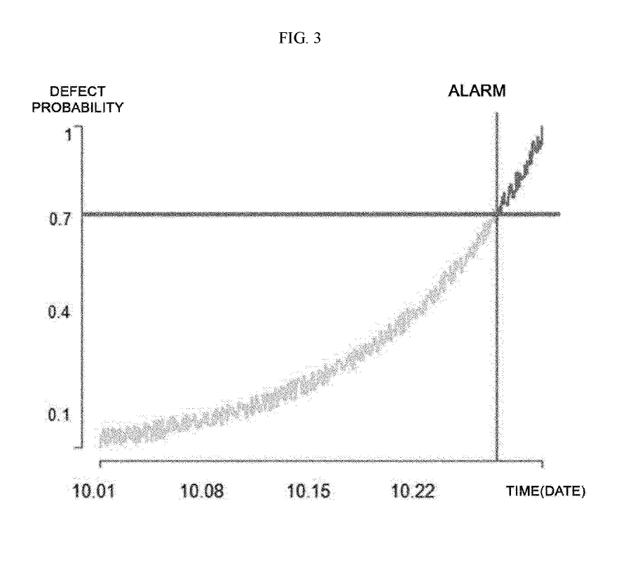

FIG. 3 is a graph showing a defect probability of a facility predicted by the defect probability predictor 106-2 according to an exemplary embodiment of the present invention. Here, the horizontal axis denotes time, and the vertical axis denotes a defect probability.

The defect probability predictor 106-2 may draw models, which use at least one of a generalized linear model (GLM), linear discriminant analysis (LDA), quadratic discriminant analysis (QDA), SVM, bagging, boosting, and random forest and have whether there is a defect in a facility and one or more of a plurality of health indicators respectively as a dependent variable and independent variables, and predict a defect probability of a facility. The defect probability predictor 106-2 may select a model having the least prediction error from among these models and predict a defect probability of a facility using the selected model.

The defect probability predictor 106-2 may predict a defect probability of a facility using a time-series analysis method, such as ARIMA, etc., when an independent variable is time, and may predict a defect probability of a facility using a survival analysis method, such as exponential distribution, Weibull distribution, log-logistic distribution, gamma distribution, exponential-logarithmic distribution, the Kaplan-Meier method, the Cox proportional hazard model, etc., when the dependent variable is a time-to-event. The defect probability predictor 106-2 using such a variety of methods may draw a model which has a defect probability of a facility and one or more of a plurality of health indicators respectively as a dependent variable and independent variables, and predict a defect probability of a facility more efficiently and accurately. As described below, when the defect probability predicted by the defect probability predictor 106-2 is equal to or greater than a pre-set value, the alarmer 108 generates an alarm so that a user can prepare for maintenance of the facility in advance.

Referring back to FIG. 1, the alarmer 108 generates an alarm to a user in consideration of one or more of a remaining lifespan of a facility, a defect probability of the facility, and a defect occurrence ratio of the facility. As shown in FIG. 1, the alarmer 108 may include a first alarmer 108-1 and a second alarmer 108-2.

The first alarmer 108-1 generates a first alarm in consideration of the remaining lifespan or the defect probability of the facility predicted by the defect facility predictor 106. Specifically, the first alarmer 108-1 may generate the first alarm when the remaining lifespan of the facility predicted by the defect facility predictor 106 becomes a pre-set value or less or the predicted defect probability of the facility becomes a pre-set to value or more. For example, referring to FIGS. 2 and 3, the first alarmer 108-1 may generate the first alarm when the remaining lifespan of the facility becomes 48 hours or less or the defect probability of the facility becomes 0.7 or more. Accordingly, a user may make a maintenance plan for the facility before the lifespan of the facility is over or a defect occurs, and may prevent a defect. Meanwhile, in an exemplary embodiment of the present invention, an alarm is used as a broad meaning including an alarm indication generated through a display device as well as an alarm sounded to a user through a speaker or the like.

Also, the second alarmer 108-2 predicts the occurrence of an accident through a defect occurrence ratio of a facility corresponding to a pre-set time and generates a second alarm. Here, a defect denotes a state in which a facility does not operate or operates abnormally and thus it is not possible to produce a desired product. In general, alarm rules regarding the occurrence of a defect are determined in a subjective, usual, and experiential manner. However, these alarm rules are based on an ambiguous criterion, and administration including a change in the alarm rules is difficult in the future. Accordingly, exemplary embodiments of the present invention make it possible to efficiently predict the occurrence of a defect in a facility by establishing an objective and statistical criterion of alarm rules.

First, the second alarmer 108-2 generates one or more criterion in consideration of a ratio of cases in which the second alarm has been generated but no defect actually occurs (referred to as “false alarm ratio” below) and a ratio of cases in which the second alarm has not been generated but a defect actually occurs (referred to as “leakage ratio” below) as shown in Table 1 below.

TABLE 1

Defect

| | | |
|---|---|---|
| Classification | Occurs | Not Occur |

| | | | |
|---|---|---|---|
| Alarm | Generated | — | False Alarm |
| | Not Generated | Leakage | — |

The above criterion satisfies any one of Expressions 1 to 3 below.

w₁*False alarm ratio+w₂*Leakage ratio [Expression 1]

(where w₁ is a weight coefficient for the importance of a false alarm ratio, and w₂ is a weight coefficient for the importance of a leakage ratio)

Leakage ratio s.t. False alarm ratio≤α [Expression 2]

(a leakage ratio under the condition that a false alarm ratio is a pre-set level α or less)

False alarm ratio s.t. Leakage ratio≤β [Expression 3]

(a false alarm ratio under the condition that a leakage ratio is a pre-set level β or less)

Next, the second alarmer 108-2 generates an alarm rule that optimizes the criterion. Here, the alarm rule may indicate, for example, “k or more of K health indicators have lately (during a pre-set time) deviated from a pre-set management line.” However, this is just an exemplary embodiment, and the second alarmer 108-2 may generate various alarm rules. For example, the second alarmer 108-2 may generate various alarm rules, such as an alarm rule “one or more of L health indicators have lately been increased or reduced,” an alarm rule “m or more of M health indicators have lately been biased towards one side from a target value,” an alarm rule “n or more of N health indicators have lately changed in direction and deviated from the management line,” and the like. Here, for convenience of description, the alarm rule “k or more of K health indicators have lately (during the pre-set time) deviated from the pre-set management line” will be described as an example.

In this case, the second alarmer 108-2 may calculate values of K and k (L and l, M and m, N and n, or the like) which minimize a value of the criterion.

For example, when the criterion is “False alarm ratio s.t. Leakage ratio≤β,” an optimal alarm rule may be calculated as follows.

arg min(False alarm ratio s.t. Leakage ratio≤β)

Here, when several values of K and k have the same false alarm ratio, the second alarmer 108-2 may select values of K and k which have the smallest value of K+k as final values of K and k for the alarm rule. When there are several combinations of K+k, the second alarmer 108-2 selects a combination in which K has the smallest value.

For example, if it is calculated that K=5 and k=4 through the above process, the second alarmer 108-2 may generate the second alarm when four or more of five health indicators deviate from the management line during the pre-set time. In other words, the second alarmer 108-2 may generate one or more criteria, generate an alarm rule which optimizes the criteria, and generate the second alarm when a defect occurrence ratio of a facility satisfies the alarm rule. Accordingly, it is possible to predict occurrence of a defect according to characteristics of a product or equipment and generate an optimized alarm.

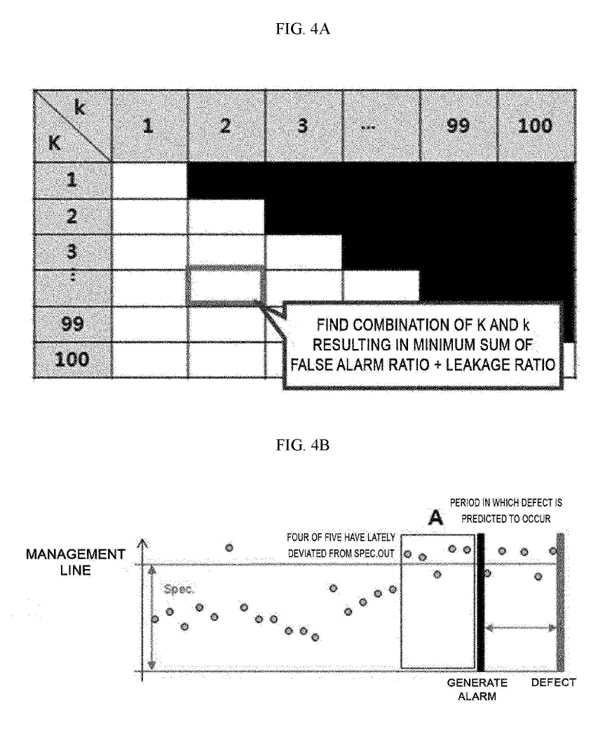

FIGS. 4A and 4B are example diagrams of a case in which a second alarm is generated by the second alarmer 108-2. As shown in FIG. 4A, the second alarmer 108-2 generates one or more criteria in consideration of the false alarm ratio and the leakage ratio and generates an alarm rule which optimizes the criteria. Through the above process, the second alarmer 108-2 may calculate values of K and k for the alarm rule, and it is assumed here that K=5 and k=4.

Subsequently, the second alarmer 108-2 may generate the second alarm in a period A in which the alarm rule is satisfied (four or more of five health indicators are found to deviate from the management line) as shown in FIG. 4B. In other words, the second alarmer 108-2 may generate the second alarm when a ratio of health indicators deviating from the management line during the pre-set time is 80% or more.

Referring back to FIG. 1, the time-of-maintenance calculator 110 calculates an optimal maintenance time point in consideration of the repair cost of a defective facility and the opportunity cost for replacing the defective facility. Here, the repair cost denotes loss that is caused by a repair time of the facility lengthening over time and a defect of the facility worsening over time, and the opportunity cost denotes profit that is obtained by using the facility until a lifespan thereof is over.

First, the time-of-maintenance calculator 110 may calculate the repair cost of a defective facility according to Expression 4 or 5 below.

Repair cost=(ET+TI*t)*M*B [Expression 4]

(where ET is an estimated repair time of a particular facility, TI is a repair time increment per unit time, M is the number of manufactures produced per unit time, B is a profit per product, t=0, . . . , and T, and T is a remaining lifespan when the first alarm is generated)

Repair cost=(EC+CI*t) [Expression 5]

(where EC is an estimated repair cost of a particular facility, CI is a repair cost increment per unit time, t=0, . . . , and T, and T is a remaining lifespan when the first alarm is generated)

Also, the time-of-maintenance calculator 110 may calculate the opportunity cost of the defective facility according to Expression 6 below.

Opportunity cost=(T−t)*V/L [Expression 6]

(where V is a price of a particular facility, L is an average lifespan, t=0, . . . , and T, and T is a remaining lifespan when the first alarm is generated)

The time-of-maintenance calculator 110 may determine a time point at which the sum of the repair cost and the opportunity cost of the defective facility is minimized as the optimal maintenance time point.

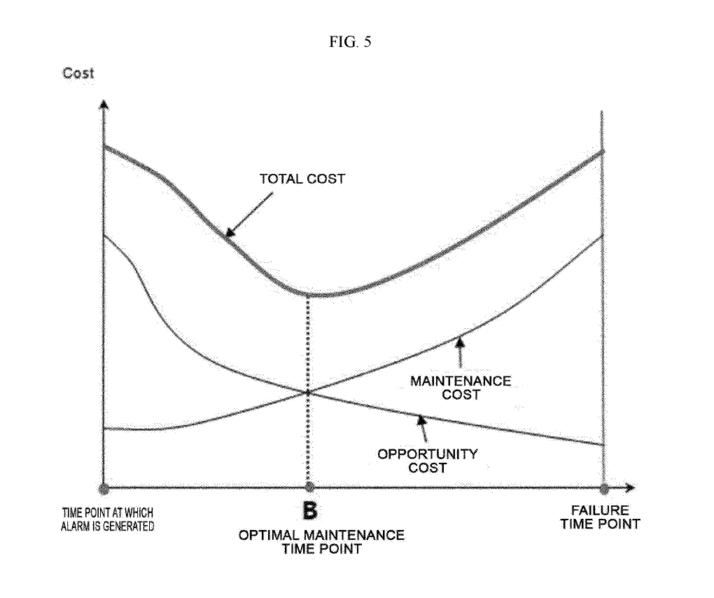

FIG. 5 is a diagram illustrating a process in which the time-of-maintenance calculator 110 calculates an optimal maintenance time point according to an exemplary embodiment of the present invention. As shown in FIG. 5, the time-of-maintenance calculator 110 may calculate the repair cost and the opportunity cost of the defective facility according to Expressions 4 to 6 above and calculate a time point B at which the sum of the repair cost and the opportunity cost is minimized. Accordingly, B in FIG. 5 may be the optimal maintenance time point.

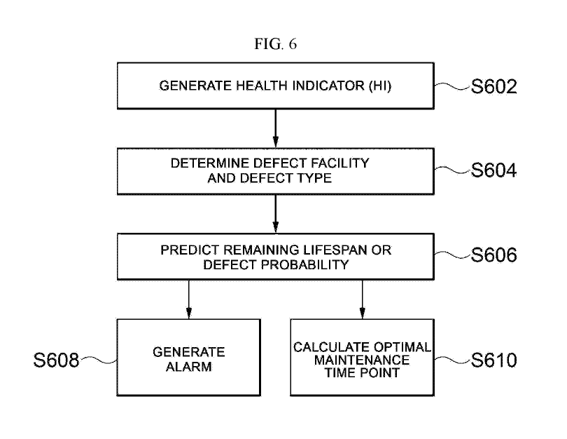

FIG. 6 is a flowchart illustrating a method for predictive maintenance of a facility according to an exemplary embodiment of the present invention.

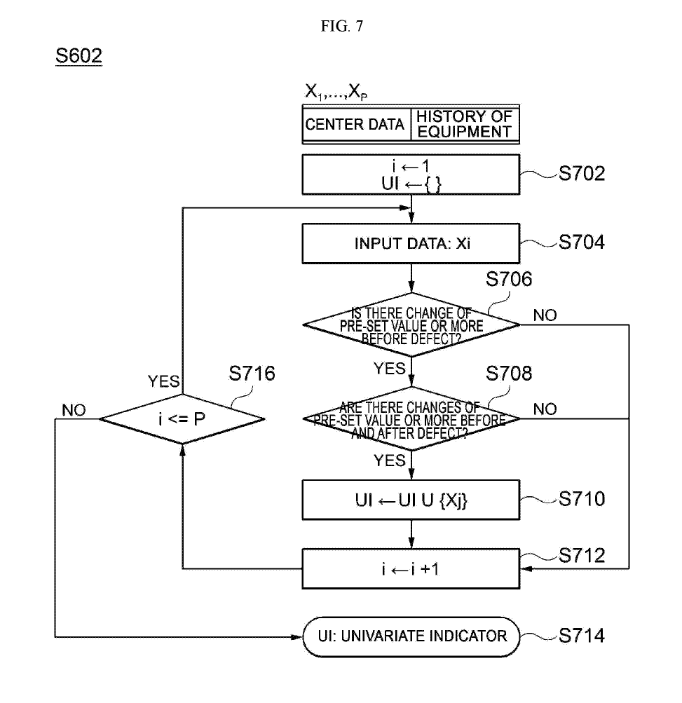

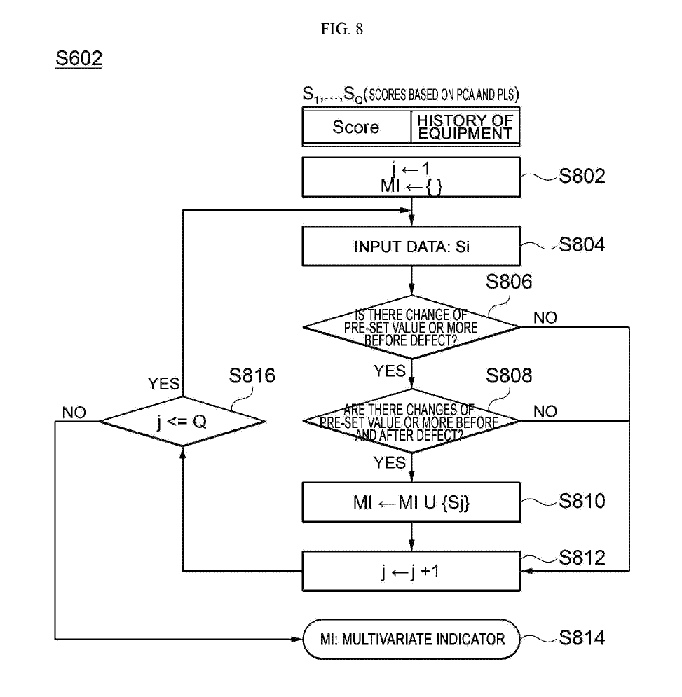

First, the health indicator generator 102 generates health indicators which are used to determine a normal state or a defect state of a facility (S602). As described above, a health indicator may include a univariate indicator composed of one variable for determining the normal state or the defect state of a facility and a multivariate indicator composed of a combination of a plurality of variables. Here, a variable may be any one of temperature, pressure, voltage, current, speed, and tension corresponding to a particular facility. A method in which the health indicator generator 102 generates a univariate indicator and a multivariate indicator will be described in detail with reference to FIGS. 7 and 8.

Next, the defect facility determiner 104 determines whether the facility is a defective facility and a defect type of the facility through the health indicators (S604). Since each health indicator generated by the health indicator generator 102 is previously matched to one or more facilities, the defect facility determiner 104 may easily determine a facility in which a defect has occurred while monitoring the health indicators. Also, the defect facility determiner 104 may easily determine a defect type of a defective facility by checking variables in a univariate indicator and a multivariate indicator included in a health indicator which has caused the facility to be determined as being defective. In other words, according to exemplary embodiments of the present invention, it is possible to efficiently identify a defect factor, which is not conventionally identified, using a multivariate analysis technique.

Next, the defect facility predictor 106 predicts a remaining lifespan and a defect probability of the defective facility (S606). As described above, the defect facility predictor 106 may include the remaining lifespan predictor 106-1 and the defect probability predictor 106-2.

The remaining lifespan predictor 106-1 may draw models, which use at least one of MLR, PLS, ridge, LASSO, SCAD, MCP, SVM, bagging, boosting, and random forest and have a remaining lifespan of a facility and one or more of a plurality of health indicators respectively as a dependent variable and independent variables, and predict a remaining lifespan of the facility. The remaining lifespan predictor 106-1 may select a model having the least prediction error from among these models and predict a remaining lifespan of the defective facility using the selected model. Also, the defect probability predictor 106-2 may draw models, which use at least one of a GLM, LDA, QDA, SVM, bagging, boosting, and random forest and have whether there is a defect in a facility and one or more of a plurality of health indicators respectively as a dependent variable and independent variables, and predict a defect probability of the facility. The defect probability predictor 106-2 may select a model having the least prediction error from among these models and predict a defect probability of the defective facility using the selected model

Next, the alarmer 108 generates an alarm to a user in consideration of one or more of the remaining lifespan of the facility, the defect probability of the facility, and a defect occurrence ratio (S608). As described above, the alarmer 108 may include the first alarmer 108-1 and the second alarmer 108-2.

The first alarmer 108-1 generates a first alarm in consideration of the remaining lifespan or the defect probability of the facility predicted by the defect facility predictor 106. Specifically, the first alarmer 108-1 may generate the first alarm when the remaining lifespan of the facility predicted by the defect facility predictor 106 becomes a pre-set value or less or the predicted defect probability of the facility becomes a pre-set value or more. Accordingly, the user may make a maintenance plan for the facility before the lifespan of the facility is over or a defect occurs, and may prevent a defect.

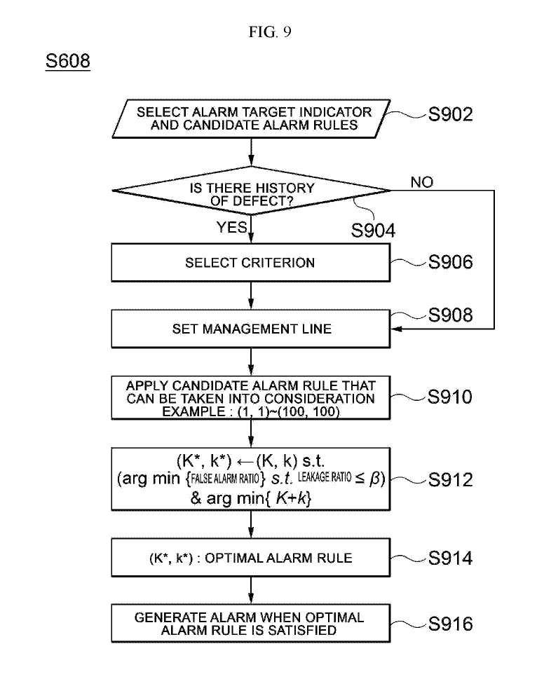

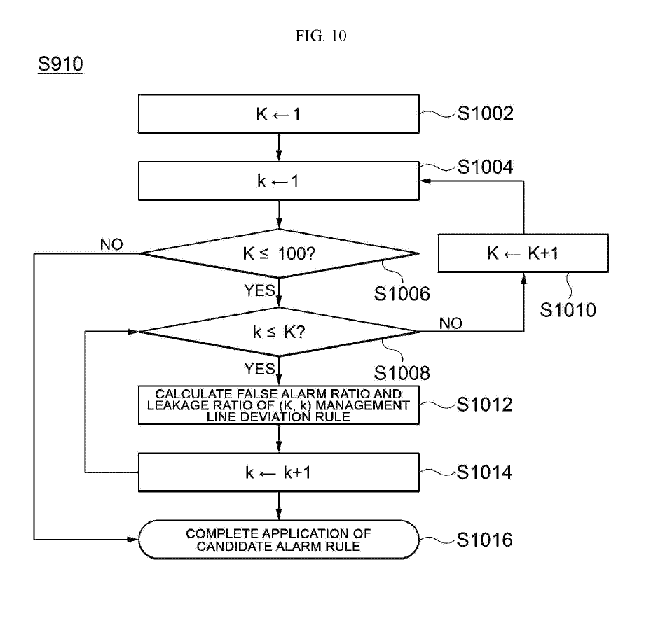

Also, the second alarmer 108-2 predicts the occurrence of an accident through a defect occurrence ratio of the facility corresponding to a pre-set time and generates a second alarm. A method in which the second alarmer 108-2 generates the second alarm will be described in detail with reference to FIGS. 9 and 10.

Finally, the time-of-maintenance calculator 110 calculates an optimal maintenance time point in consideration of a repair cost of the defective facility and an opportunity cost for replacing the defective facility (S610). The time-of-maintenance calculator 110 may calculate the repair cost of the defective facility according to Expression 4 or 5 described above and calculate the opportunity cost of the defective facility according to Expression 6. Subsequently, the time-of-maintenance calculator 110 may determine a time point at which the sum of the repair cost and the opportunity cost of the defective facility is minimized as an optimal maintenance time point. Meanwhile, although it has been described above that step S610 is performed after step S608, step S608 and step S610 may be simultaneously performed as separate steps, or step S608 may be performed after step S610.

FIG. 7 is a flowchart illustrating a method of selecting a univariate indicator according to an exemplary embodiment of the present invention in step S602 of FIG. 6.

First, the health indicator generator 102 may receive one piece of input data X₁ among a plurality of pieces of input data Xᵢ from a plurality of sensors (e.g., a temperature sensor, a pressure sensor, etc.) disposed in or near the facility (S702 and S704). Here, the input data Xᵢ may be a variable regarding any one of temperature, pressure, voltage, current, speed, and tension corresponding to a particular facility.

Next, the health indicator generator 102 monitors the input data X₁ to check whether the piece of input data X₁ is changed by a pre-set value or more before a defect of the facility (S706). For example, when the piece of input data X₁ is a variable regarding a temperature of a first facility, the health indicator generator 102 may monitor whether the piece of input data X₁ is changed by the pre-set value, for example, 1 degree, or more before a defect of the facility.

When the piece of input data X₁ is changed by the pre-set value or more, the health indicator generator 102 monitors the piece of input data X₁ to check whether the piece of input data X₁ is changed by a pre-set value or more before and after the defect of the facility (S708). For example, the health indicator generator 102 may monitor whether the piece of input data X₁ is changed by the pre-set value, for example, 3 degrees, or more before the defect of the facility.

When there are changes of the pre-set values or more in both steps S706 and S708 described above, the health indicator generator 102 selects the piece of input data X₁ as a univariate indicator UI (S710).

Subsequently, the health indicator generator 102 increases i by 1 (where i≤P) and repeats the process from step S704 (S712 and S716). Even when there is no change of the pre-set value or more in at least one of steps S706 and S708, the health indicator generator 102 increases i by 1 (where i≤P) and repeats the process from step S704.

When i≤P is not satisfied in step S716, a univariate indicator which has hitherto been selected is selected as a final univariate indicator (S714). Meanwhile, the pre-set values of steps S706 and S708 may be determined using an experiential distribution, a distribution of a variable which is known to best reflect a defect of the corresponding facility, or bootstrap sampling.

FIG. 8 is a flowchart illustrating a method of selecting a multivariate indicator according to an exemplary embodiment of the present invention in step S602 of FIG. 6.

First, the health indicator generator 102 may receive one piece of input data S₁ among a plurality of pieces of input data Sᵢ composed of a combination of a plurality of variables using PCA, PLS, or the like (S802 and S804). Here, a variable may be any one of temperature, pressure, voltage, current, speed, and tension corresponding to a particular facility, and the input data Sᵢ may be, for example, a*temperature+b*pressure+c*voltage (where a, b, and c are constants).

Next, the health indicator generator 102 monitors the piece of input data S₁ to check whether the piece of input data S₁ is changed by a pre-set value or more before a defect of the facility (S806).

When the piece of input data S₁ is changed by the pre-set value or more, the health indicator generator 102 monitors the piece of input data S₁ to check whether the piece of input data S₁ is changed by a pre-set value or more before and after the defect of the facility (S808).

When there are changes of the pre-set values or more in both steps S806 and S808 described above, the health indicator generator 102 selects the piece of input data S₁ as a multivariate indicator MI (S810).

Subsequently, the health indicator generator 102 increases i by 1 (where i≤Q) and repeats the process from step S804 (S812 and S816). Even when there is no change of the pre-set value or more in at least one of steps S806 and S808, the health indicator generator 102 increases i by 1 (where i≤Q) and repeats the process from step S804.

When i≤Q is not satisfied in step S816, a multivariate indicator which has hitherto been selected is selected as a final multivariate indicator (S814). Meanwhile, the pre-set values of steps S806 and S808 may be determined using an experiential distribution, a distribution of a variable which is known to best reflect a defect of the corresponding facility, or bootstrap sampling.

FIG. 9 is a flowchart illustrating a method in which the second alarmer 108-2 generates the second alarm according to an exemplary embodiment of the present invention in step S608 of FIG. 6.

First, the second alarmer 108-2 determines an alarm target indicator and candidate alarm rules (S902). Here, the alarm target indicator is a health indicator that is used to generate the second alarm among the plurality of health indicators and may be, for example, a health indicator matched to the defective facility. Also, candidate alarm rules may include, for example, an alarm rule “k or more of K health indicators deviate from a pre-set management line during a pre-set time,” an alarm rule “one or more of L health indicators are increased or reduced during a pre-set time,” an alarm rule “m or more of M health indicators are biased towards one side from a target value during a pre-set time,” an alarm rule “n or more of N health indicators have changed in direction and deviated from the management line during a pre-set time,” and the like.

The second alarmer 108-2 determines whether the facility has a history of defect (S904) and selects a criterion when the facility has a history of defect (S906). The criterion may satisfy any one of Expressions 1 to 3 described above. For convenience of description, it is assumed here that the second alarmer 108-2 selects a criterion satisfying Expression 2.

Next, the second alarmer 108-2 sets a management line (S908). Here, the management line is a reference line that is used to distinguish between a normal facility and a defective facility and may vary according to the kind of the health indicator. The second alarmer 108-2 may set the management line using, for example, an experiential distribution or bootstrap sampling. Referring back to FIG. 4B, an example of a management line is shown. When it is determined in step S904 that the facility has no history of defect, the second alarmer 108-2 may skip step S906 and directly set the management line. In this case, there is no criterion, and thus it is possible to use only a condition that values of K+k are minimized in step S912 to be described below. When there are several combinations of K+k, only a condition that a value of K is minimized is used.

Next, the second alarmer 108-2 applies candidate alarm rules that can be taken into consideration (S910). For example, when an alarm rule is “k or more of K health indicators deviate from a pre-set management line during a pre-set time,” the second alarmer 108-2 may sequentially apply values of (K, k)=(1, 1), (1, 2), (1, 3), . . . , and (100, 100) to the criterion. This will be described in detail with reference to FIG. 10.

Next, the second alarmer 108-2 finds values of K and k (referred to as K* and k* below) that minimize a value of the criterion and a value of K+k and selects an alarm rule having K* and k* as an optimal alarm rule (S912 and S914).

Finally, the second alarmer 108-2 generates the second alarm when the optimal alarm rule selected in step S914 is satisfied (S916).

FIG. 10 is a flowchart illustrating step S910 of FIG. 9.

First, the second alarmer 108-2 assumes that K=1 and k=1 and then determines whether k≤K is satisfied under the condition of K≤100 (S1002, S1004, S1006, and S1008).

When k≤K is not satisfied, the second alarmer 108-2 increases K by 1 and repeats the process from step S1004 (S1010).

When k≤K is satisfied, the second alarmer 108-2 calculates a false error ratio and a leakage ratio with respect to current values of K and k (S1012). The second alarmer 108-2 may identify cases in which the second alarm is generated and cases in which an accident actually occurs from samples of a particular number (e.g., 100) of facilities and calculate a false error ratio and a leakage ratio in relation to the set management line. Also, the second alarmer 108-2 may calculate a false error ratio and a leakage ratio using a simulator.

Next, the second alarmer 108-2 increases k by 1 and repeats the process from step S1008 (S1014).

When K≤100 is not satisfied any more in step S1006, the second alarmer 108-2 completes application of candidate alarm rules (S1016). Through this process, it is possible to apply all candidate alarm rules with respect to k=1 to k=100 and K=1 to K=100. For convenience of description, it is assumed here that (k, K)=(100, 100) are maximums of k and K. However, this is just an example, and maximums of k and K are not limited thereto.

While the present invention has been described in detail above through representative embodiments, those of ordinary skill in the art would understand that various modifications can be made from the described embodiments without departing from the scope of the present invention. Therefore, the scope of the present invention is not to be determined by the described embodiments but to be determined by the claims and equivalents of the claims.

### REFERENCE SIGNS LIST

100: system for predictive maintenance of a facility
102: health indicator generator
104: defect facility determiner
106: defect facility predictor
106-1: remaining lifespan predictor
106-2: defect probability predictor
108: alarmer
108-1: first alarmer
108-2: second alarmer
110: time-of-maintenance calculator

1. A system for predictive maintenance of a facility, the system comprising:
a health indicator generator configured to generate health indicators for determining a normal state or a defect state of a facility;
a defect facility determiner configured to determine whether the facility is a defective facility and a defect type of the facility based on the health indicators;
a defect facility predictor configured to predict a remaining lifespan or a defect probability of the facility;
a first alarmer configured to generate a first alarm when the predicted remaining lifespan becomes a pre-set value or less or the predicted defect probability becomes a pre-set value or more; and
a second alarmer configured to generate a second alarm based on a defect occurrence ratio of the facility corresponding to a pre-set time,
wherein the second alarmer generates one or more criteria in consideration of a ratio of cases in which the second alarm has been generated but no defect actually occurs (referred to as “false alarm ratio”) and a ratio of cases in which the second alarm has not been generated but a defect actually occurs (referred to as “leakage ratio”), generates an alarm rule based on the criteria, and generate the second alarm when the alarm rule is satisfied, and
the criteria satisfy any one of Expressions 1 to 3 below:
w₁*False alarm ratio+w₂*Leakage ratio [Expression 1]
where w₁ is a weight coefficient for importance of a false alarm ratio, and w₂ is a weight coefficient for importance of a leakage ratio;
Leakage ratio s.t. False alarm ratio≤α [Expression 2]
wherein the leakage ratio under a condition that a false alarm ratio is a pre-set level α or less; and
False alarm ratio s.t. Leakage ratio≤β [Expression 3]
where the false alarm ratio under a condition that a leakage ratio is a pre-set level β or less.

2. The system of claim 1, wherein the health indicators include a univariate indicator composed of one variable for determining the normal state or the defect state of a facility and a multivariate indicator composed of a combination of a plurality of variables.

3. The system of claim 2, wherein the health indicator generator selects a variable, which is changed by a pre-set value or more before a defect of the facility and is changed by a pre-set value or more before and after the defect of the facility, as the univariate indicator from among the plurality of variables.

4. The system of claim 2, wherein the health indicator generator selects a combination, which is changed by a pre-set value or more before a defect of the facility and is changed by a pre-set value or more before and after the defect of the facility, as the multivariate indicator from among a plurality of combinations of the variables.

5. The system of claim 2, wherein the variable is any one of temperature, pressure, voltage, current, speed, and tension indicating a state or a processing condition of a particular facility.

6. (canceled)

7. The system of claim 2, wherein when the health indicators deviate from a pre-set management line, the defect facility determiner determines the facility as a defective facility and determines the defect type of the facility by checking kinds of the univariate indicator and the multivariate indicator included in the health indicators.

8. The system of claim 1, wherein the defect facility predictor draws a model, which uses at least one of multiple linear regression (MLR), partial least squares (PLS), ridge, least absolute shrinkage and selection operator (LASSO), smoothly clipped absolute deviation (SCAD), minimax concave penalty (MCP), support vector machine (SVM), bagging, boosting, and random forest and has the remaining lifespan of the facility and one or more of the plurality of health indicators respectively as a dependent variable and independent variables, and predicts the remaining lifespan of the facility.

9. The system of claim 1, wherein the defect probability predictor draws a model, which uses at least one of a generalized linear model (GLM), linear discriminant analysis (LDA), quadratic discriminant analysis (QDA), support vector machine (SVM), bagging, boosting, and random forest and has whether there is a defect in the facility and one or more of the plurality of health indicators respectively as a dependent variable and independent variables, and predicts the defect probability of the facility.

10. The system of claim 1, wherein the alarm rule indicates that k or more of K health indicators deviate from a pre-set management line during the pre-set time, and
the second alarmer calculates values of K and k minimizing values of the criteria.

11. (canceled)

12. (canceled)

13. (canceled)

14. A method for predictive maintenance of a facility, the method comprising:
generating, by a health indicator generator, health indicators for determining a normal state or a defect state of a facility;
determining, by a defect facility determiner, whether the facility is a defective facility and a defect type of the facility through the health indicators;
predicting, by a defect facility predictor, a remaining lifespan or a defect probability of the facility;
generating, by a first alarmer, a first alarm when the predicted remaining lifespan becomes a pre-set value or less or the predicted defect probability becomes a pre-set value or more; and
generating, by a second alarmer, a second alarm based on a defect occurrence ratio of the facility corresponding to a pre-set time,
wherein the generating of the second alarm comprises generating one or more criteria in consideration of a ratio of cases in which the second alarm has been generated but no defect actually occurs (referred to as “false alarm ratio”) and a ratio of cases in which the second alarm has not been generated but a defect actually occurs (referred to as “leakage ratio”), generating an alarm rule based on the criteria, and generating the second alarm when the alarm rule is satisfied, and
the criteria satisfy any one of Expressions 1 to 3 below:
w₁*False alarm ratio+w₂*Leakage ratio [Expression 1]
where w₁ is a weight coefficient for importance of a false alarm ratio, and w₂ is a weight coefficient for importance of a leakage ratio;
Leakage ratio s.t. False alarm ratio≤α [Expression 2]
wherein the leakage ratio under a condition that a false alarm ratio is a pre-set level α or less; and
False alarm ratio s.t. Leakage ratio≤β [Expression 3]
where the false alarm ratio under a condition that a leakage ratio is a pre-set level β or less.

15-26. (canceled)
